(19) United States
(12) Patent Application Publication
(10) Pub. No.: US 2026/0302643 A1
(43) Pub. Date: Oct. 1, 2026

(54) ANTENNA MODULE AND ELECTRONIC DEVICE

(71) Applicant: Coretronic Intelligent Robotics Corporation, Hsin-Chu (TW)

(72) Inventors: Chun-Yi Li, Hsin-Chu (TW); Cheng-Shen Lee, Hsin-Chu (TW)

(73) Assignee: Coretronic Intelligent Robotics Corporation, Hsin-Chu (TW)

(21) Appl. No.: 19/564,223

(22) Filed: Mar. 12, 2026

(30) Foreign Application Priority Data
Mar. 28, 2025 (TW) 114111991

(51) Int. Cl. H01Q 19/13; H01Q 19/10

(52) U.S. Cl. CPC H01Q 19/138; H01Q 19/104

(57) ABSTRACT

An antenna module includes an antenna plate and a reflection plate. The antenna plate includes a first base plate and an antenna structure located on a surface of the first base plate. The antenna structure includes a feed source, a first wire pattern for transmitting a first electromagnetic wave signal having a first frequency, and a second wire pattern for transmitting a second electromagnetic wave signal having a second frequency. The first and second wire patterns have first and second lengths respectively. The first frequency is less than the second frequency and the first length is greater than the second length. The reflection plate includes a second base plate and a reflection pattern located on a surface of the second base plate. A projection of the antenna structure on the reflection plate at least partially overlaps the reflection pattern. An electronic device including the antenna module is also disclosed.

### CROSS-REFERENCE TO RELATED APPLICATION

This application claims the priority benefit of Taiwan application serial no. 114111991, filed on March 28, 2025. The entirety of the above-mentioned patent application is hereby incorporated by reference herein and made a part of this specification.

### BACKGROUND

### Technical Field

The disclosure relates to an antenna module, and particularly relates to an antenna module including a dipole antenna structure and a base plate capable of reflecting electromagnetic wave signals.

### Description of Related Art

With the development of technology, users' performance requirements for antenna communication transmission have accordingly improved. For example, a typical dipole antenna may be combined with a reflection plate to increase radiation gain. However, an undesigned reflection plate may easily affect the radiation pattern of electromagnetic wave and efficiency generated by the antenna. How to design an antenna with good transmission performance is one of the goals that researchers in this field are striving to study.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an antenna module, which has good antenna performance and may effectively reduce the volume of the antenna module. In addition, the antenna module also has the effect of improved gain and maintains the omnidirectionality of the radiation pattern of electromagnetic wave.

Other objects and advantages of the disclosure may be further understood from the technical features disclosed in the disclosure.

In order to achieve one or a portion of or all of the above objectives or other objectives, an embodiment of the disclosure provides an antenna module, including an antenna plate and a reflection plate. The antenna plate includes a first base plate and an antenna structure. The antenna structure is disposed on the first base plate. The antenna structure includes a feed source, a plurality of first wire patterns, and a plurality of second wire patterns. Each of the first wire patterns is arranged symmetrically with the feed source as a center, each of the first wire patterns is configured to transmit a first electromagnetic wave signal having a first frequency, and each of the first wire patterns has a first length. Each of the second wire patterns is arranged symmetrically with the feed source as a center, each of the second wire patterns is configured to transmit a second electromagnetic wave signal having a second frequency, and each of the second wire patterns has a second length. The first frequency is less than the second frequency and the first length is greater than the second length. The reflection plate includes a second base plate and a reflection pattern. The reflection pattern is disposed on the second base plate. A projection of the antenna structure on the reflection plate at least partially overlaps the reflection pattern.

In an embodiment of the disclosure, the antenna plate is parallel to the reflection plate.

In an embodiment of the disclosure, there is a distance between the reflection plate and the antenna plate.

In an embodiment of the disclosure, each of the first wire patterns includes a first section, a second section, a third section, and a fourth section, the first section is connected to the feed source, and the first section, the second section, the third section, and the fourth section are sequentially connected to form a plurality of bends.

In an embodiment of the disclosure, the first section and the third section extend along a first direction, the fourth section extends along a second direction, the second section is tilted with respect to the first direction and the second direction, and the first direction is perpendicular to the second direction.

In an embodiment of the disclosure, the first direction is parallel to a first side of the first base plate, and the second direction is parallel to a second side of the first base plate.

In an embodiment of the disclosure, each of the second wire patterns includes a fifth section, a sixth section, and a seventh section, the fifth section is connected to the feed source, and the fifth section, the sixth section, and the seventh section are sequentially connected to form a plurality of bends.

In an embodiment of the disclosure, the fifth section and the seventh section extend along the second direction, and the sixth section extends along the first direction.

In an embodiment of the disclosure, the reflection pattern further includes a first section and two second sections, and the two second sections are parallel to the first section and respectively located on two opposite sides of the first section.

In an embodiment of the disclosure, a length of each of the second sections is less than a quarter wavelength of the first frequency.

In an embodiment of the disclosure, a length of each of the second sections is between 20 and 25 millimeters.

In an embodiment of the disclosure, the second base plate includes two opposite first sides and two opposite second sides, the two first sides are perpendicular to the two second sides, the first section is parallel to each of the first sides, and the two ends of the first section are respectively located at the midpoint positions of the two second sides of the second base plate.

In an embodiment of the disclosure, the reflection pattern further includes at least one extension part and at least one corner part, the reflection plate is rectangle, the at least one corner part is located in at least one of the four corners of the reflection plate, and the extension part is parallel to each of the second sides and located between the first section and the at least one corner part.

In an embodiment of the disclosure, there is a gap between the two opposite ends of the second section and the at least one extension part.

In an embodiment of the disclosure, a number of the at least one extension part is two, which are located on the two second sides.

In an embodiment of the disclosure, a number of the at least one corner part is four, which are located at the four corners of the reflection plate.

In an embodiment of the disclosure, a shape of the at least one corner part is triangle.

In order to achieve one or a portion of or all of the above objectives or other objectives, an embodiment of the disclosure provides an electronic device, where the electronic device at least includes a processor and the antenna module mentioned above. The antenna module is electrically connected to the processor. The electronic device transmits electromagnetic wave signals via the antenna module.

Based on the above, the embodiments of the disclosure have at least one of the following advantages or effects. In the design of the antenna module of the disclosure, the first length of the first wire pattern of the antenna structure is greater than the second length of the second wire pattern, and the projection of the antenna structure on the reflection plate at least partially overlaps the reflection pattern on the reflection plate. By adjusting the impedance of electromagnetic wave signal transmission and matching with the reflection pattern of the reflection plate, the antenna module of the disclosure has the effect of improved gain and maintains the omnidirectionality of the radiation pattern of electromagnetic wave, and may also effectively reduce the volume of the antenna module.

In order to make the above-mentioned features and advantages of the disclosure clearer and easier to understand, the following embodiments are given and described in details with accompanying drawings as follows.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

FIG. 1 is a schematic side-view diagram of an antenna module according to an embodiment of the disclosure.

FIG. 2 is a schematic diagram of the antenna plate of the antenna module of FIG. 1.

FIG. 3 is a schematic diagram of the reflection plate of the antenna module of FIG. 1.

FIG. 4 is a relationship diagram of voltage standing wave ratio (VSWR) versus frequency (Freq) of the antenna module of FIG. 1.

FIG. 5 is a relationship diagram of return loss versus frequency (Freq) of the antenna module of FIG. 1.

FIGS. 6A to 6D are diagrams of the radiation pattern of electromagnetic wave of the antenna module of FIG. 1 at different frequencies.

FIG. 7 is a relationship diagram of gain versus frequency (Freq) of the antenna module of FIG. 1.

FIG. 8 is a schematic diagram of an electronic device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as "top," "bottom," "front," "back," etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. As such, the directional terminology is used for purposes of illustration and is in no way limiting.

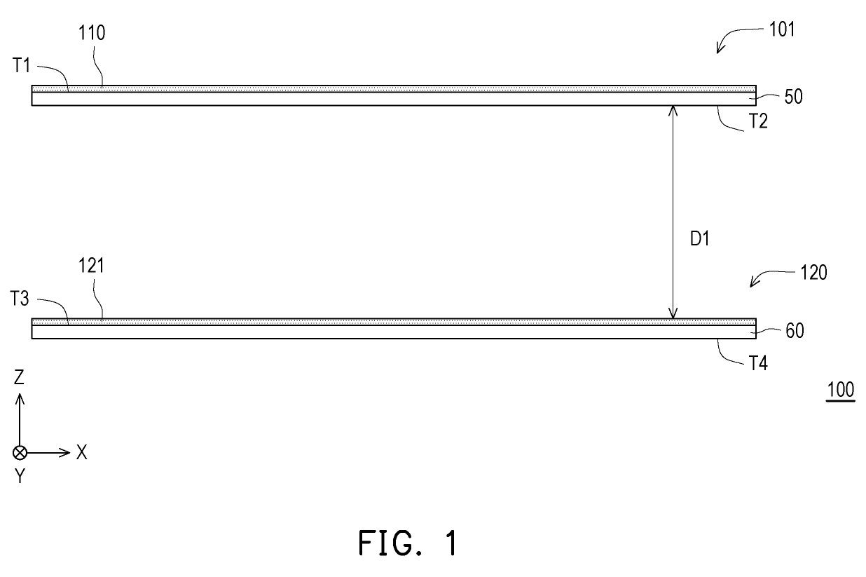

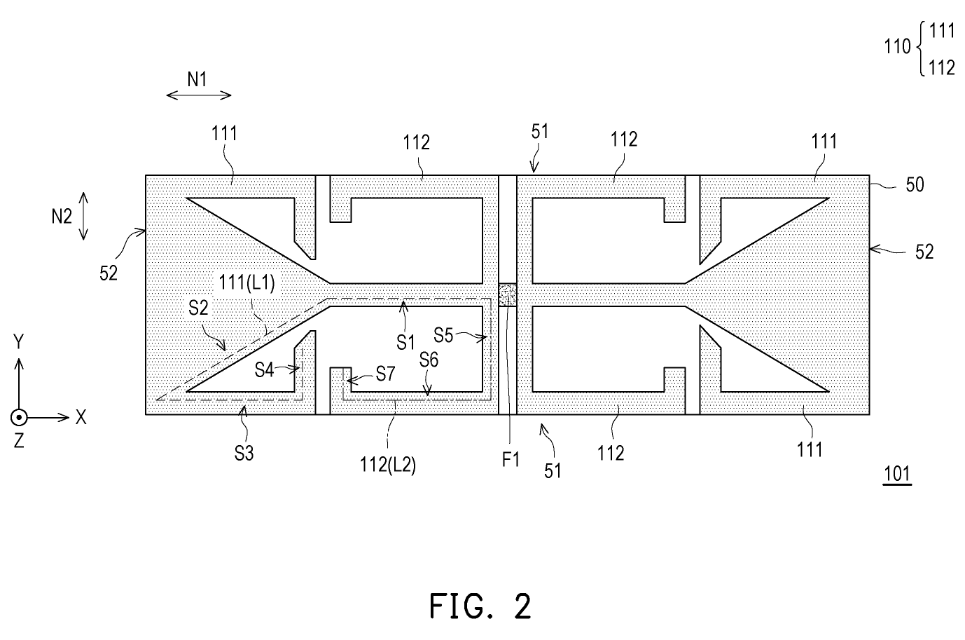

FIG. 1 is a schematic side-view diagram of an antenna module according to an embodiment of the disclosure. FIG. 2 is a schematic diagram of the antenna plate of the antenna module of FIG. 1. It should be noted that in FIG. 2, the wire paths of electromagnetic waves at 2.4GHz and 5GHz are illustratively drawn with different line types (dashed lines and chain lines) respectively, but the frequency of the electromagnetic waves is not limited by the disclosure.

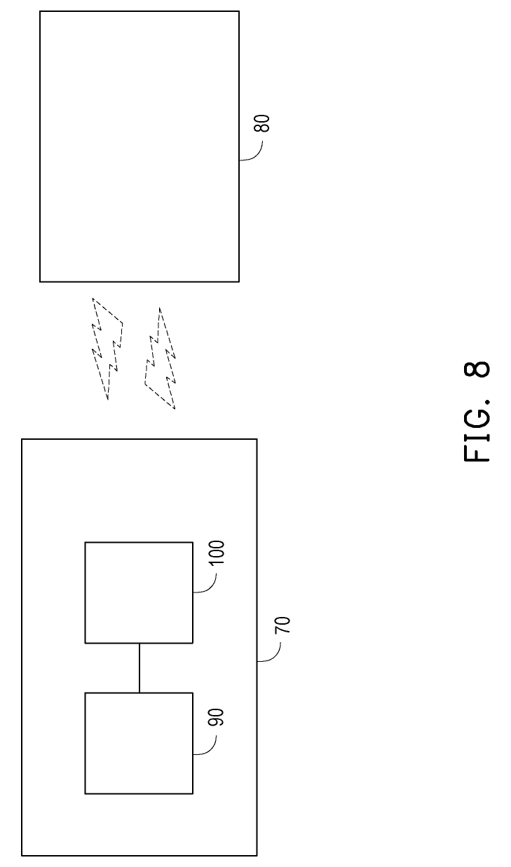

Referring to FIGS. 1 and 2, an antenna module 100 of this embodiment includes an antenna plate 101 and a reflection plate 120. The antenna module 100 belongs to a mechanical structure. The antenna plate 101 includes an antenna structure 110 and a first base plate 50. The antenna structure 110 is disposed on a surface of the first base plate 50. In this embodiment, the antenna structure 110 includes a feed source F1, a plurality of first wire patterns 111, and a plurality of second wire patterns 112. In an embodiment, the feed source F1 is configured to provide electromagnetic wave signals to the first wire patterns 111 or the second wire patterns 112, and transmit electromagnetic wave signals to an external electronic device 80 (refer to FIG. 8). In another embodiment, the feed source F1 is configured to receive electromagnetic wave signals transmitted from the external electronic device 80 via the reception of the first wire patterns 111 or the second wire patterns 112. In yet another embodiment, the feed source F1 may have the functions of receiving electromagnetic wave signals and providing electromagnetic wave signals. From the above embodiments, it can be known that the so-called transmission of electromagnetic wave signals may include transmitting, receiving, or transmitting and receiving electromagnetic wave signals, designed according to actual usage situations.

Here, the feed source F1 is located at the center of the base plate 50. In this embodiment, each of the first wire patterns 111 is arranged symmetrically with the feed source F1 as the center, and each of the second wire patterns 112 is arranged symmetrically with the feed source F1 as the center. Here, the antenna structure 110 is a dipole antenna structure.

Dipole antennas in printed circuit board (PCB) form have the problem of excessive size, with sizes such as 43.5x12.5x0.6 millimeters (mm), which is not conducive to installation in products requiring small volume. In addition, introducing an undesigned reflection plate may cause the problem of the radiation pattern of electromagnetic wave being compressed and having asymmetric directionality. The antenna module of the disclosure may solve the above problems.

In this embodiment, the first wire pattern 111 is configured to transmit a first electromagnetic wave signal having a first frequency, and the wire of the first wire pattern 111 has a first length L1. The second wire pattern 112 is configured to transmit a second electromagnetic wave signal having a second frequency, and the wire of the second wire pattern 112 has a second length L2. The first length L1 is greater than the second length L2. Here, the first frequency is 2.4GHz. The second frequency is 5GHz, but the disclosure is not limited thereto. In an embodiment, the wire lengths for frequencies 2.4GHz and 5GHz are equal to or less than a quarter wavelength design, and the wires are designed as non-linear structures such as folded lines, diagonal lines, etc., to reduce the dimensions (length and width) of the base plate 50, but the disclosure is not limited thereto.

In detail, in this embodiment, the first wire pattern 111 includes a first section S1, a second section S2, a third section S3, and a fourth section S4. The first section S1 is connected to the feed source F1, and the first section S1, second section S2, third section S3, and fourth section S4 are sequentially connected to form a plurality of bends. For example, the first section S1 and the third section S3 extend along a first direction N1, the fourth section S4 extends along a second direction N2, the second section S2 is tilted with respect to the first direction N1 and the second direction N2, and the first direction N1 is perpendicular to the second direction N2. Here, the second section S2 extends towards the corner of the base plate 50 to connect to the third section S3 which is close to a first side 51 of the base plate 50, but is not limited thereto. In this embodiment, the first direction N1 is parallel to the first side 51 of the base plate 50, and the second direction N2 is parallel to a second side 52 of the base plate 50. Here, the first direction N1 is parallel to the X direction, and the second direction N2 is parallel to the Y direction, but is not limited thereto.

In this embodiment, the second wire pattern 112 includes a fifth section S5, a sixth section S6, and a seventh section S7. The fifth section S5 is connected to the feed source F1, and the fifth section S5, sixth section S6, and seventh section S7 are sequentially connected to form a plurality of bends. The fifth section S5 and the seventh section S7 extend along the second direction N2, and the sixth section S6 extends along the first direction N1.

Under the above embodiment, the dimensions of the antenna plate 101 may be reduced to 30.0x10.0x0.6mm. That is, the antenna plate 101 has a length of 30mm in the X direction, a length of 10mm in the Y direction, and a length of 0.6mm in the Z direction, but the disclosure is not limited thereto. In this way, the volumes of the antenna plate 101 and the antenna module 100 may be effectively reduced.

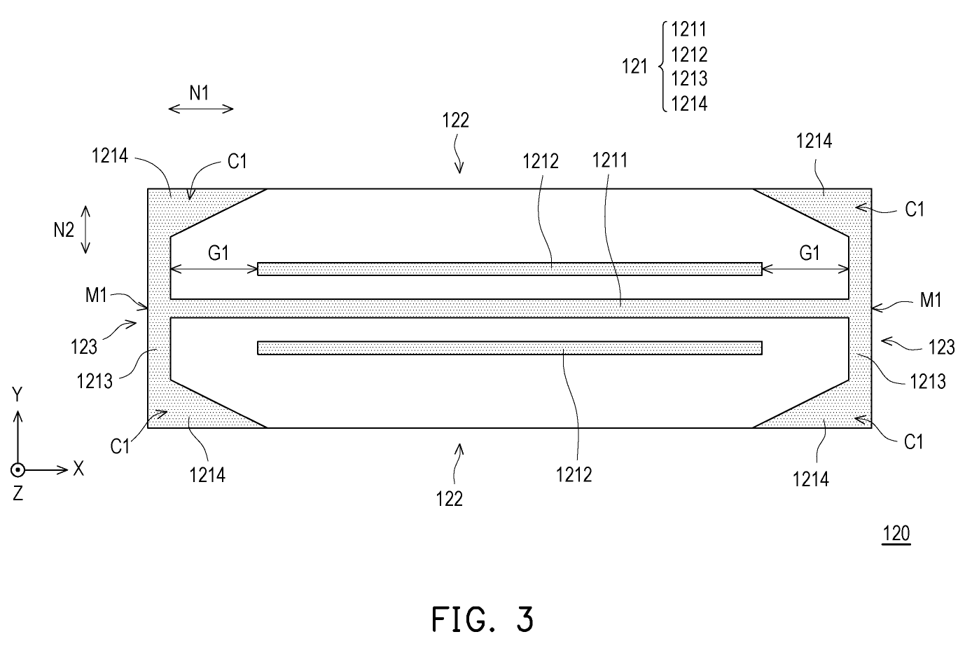

FIG. 3 is a schematic diagram of the reflection plate of the antenna module of FIG. 1. Referring to FIG. 3, in this embodiment, the reflection plate 120 includes a reflection pattern 121 and a second base plate 60. The reflection pattern 121 is disposed on a surface of the second base plate 60. The reflection pattern 121 has the effect of reflecting electromagnetic wave signals, which may enhance the gain of electromagnetic wave signals in a plurality of directions. The reflection pattern 121 includes a first section 1211 and two second sections 1212, where the two second sections 1212 are parallel to the first section 1211 and are respectively located on two opposite sides of the first section 1211. That is, the second sections 1212 are symmetrically disposed on two opposite sides of the first section 1211.

Referring to FIGS. 1 to 3, in this embodiment, the antenna plate 101 is parallel to the reflection plate 120. The orthogonal projection of the antenna structure 110 of the antenna plate 101 onto the reflection plate 120 at least partially overlaps the reflection pattern 121. That is, in the Z direction, the reflection pattern 121 of the reflection plate 120 at least partially overlaps the first wire pattern 111 and the second wire pattern 112 of the antenna structure 110, but the disclosure is not limited thereto.

In this embodiment, in the Z direction, there is a distance D1 between the reflection plate 120 and the antenna plate 101, where distance D1 may be 8 mm. In other embodiments, the distance D1 may also be between 7 mm and 9 mm, but the disclosure is not limited thereto.

Furthermore, in this embodiment, the second base plate 60 of the reflection plate 120 includes two opposite first sides 122 and two opposite second sides 123, where the two first sides 122 are perpendicular to the two second sides 123. The first section 1211 is parallel to each of the first sides 122, and the two ends of the first section 1211 are respectively located at midpoint positions M1 of the two second sides 123 of the second base plate 60.

In this embodiment, the length of each of the second sections 1212 is less than the length of a quarter wavelength of the first frequency, but the disclosure is not limited thereto. In this embodiment, the length of each of the second sections 1212 is between 20 and 25 mm, but the disclosure is not limited thereto.

In this embodiment, the first base plate 50 and the second base plate 60 may be transparent or frosted boards. The board material may be fiberglass, plastic, or other insulating materials, which is not limited by the disclosure. In an embodiment, the materials of the first wire pattern 111, the second wire pattern 112, and the reflection pattern 121 are metal, like copper.

In this embodiment, the first wire pattern 111 and the second wire pattern 112 are printed on an upper surface T1 (FIG. 1) of the first base plate 50, but is not limited thereto. In an embodiment, the first wire pattern 111 and the second wire pattern 112 may also be printed on a lower surface T2 (FIG. 1) of the first base plate 50, which is not limited by the disclosure. In this embodiment, the reflection pattern 121 is printed on an upper surface T3 (FIG. 1) of the second base plate 60, but is not limited thereto. In an embodiment, the reflection pattern 121 may also be printed on a lower surface T4 (FIG. 1) of the second base plate 60, which is not limited by the disclosure.

Under the above embodiment, the reflection pattern 121 of the reflection plate 120 is designed to correspond to the first wire pattern 111 and the second wire pattern 112 of the antenna structure 110 of the antenna plate 101. By adjusting the impedance of electromagnetic wave signal transmission through the reflective surface formed by the second sections 1212 on the reflection plate 120, and in conjunction with the reflective areas formed by other sections of the reflection pattern 121, the gain is improved while maintaining the omnidirectionality of the radiation pattern of electromagnetic wave.

Referring to FIG. 3 again, in this embodiment, the reflection pattern 121 further includes at least one extension part 1213 and at least one corner part 1214. Here, the number of the extension parts 1213 is two, which are respectively located at the two second sides 123. Specifically, the extension part 1213 is parallel to each of the second sides 123 and is located between the first section 1211 and the corner part 1214.

In this embodiment, there is a gap G1 between the two opposite ends of the second section 1212 of the reflection pattern 121 and the extension part 1213.

In an embodiment, the reflection plate 120 is rectangle, the number of the corner parts 1214 is four, and the four corner parts 1214 are respectively located at four corners C1 of the reflection plate 120. In other embodiments, at least one corner part 1214 is located in at least one of the four corners C1 of the reflection plate 120, which is not limited by the disclosure. Here, the shape of the corner part 1214 is triangle, which may reduce resistance, help reduce loss, improve reflection efficiency, and increase the gain of the electromagnetic wave signal.

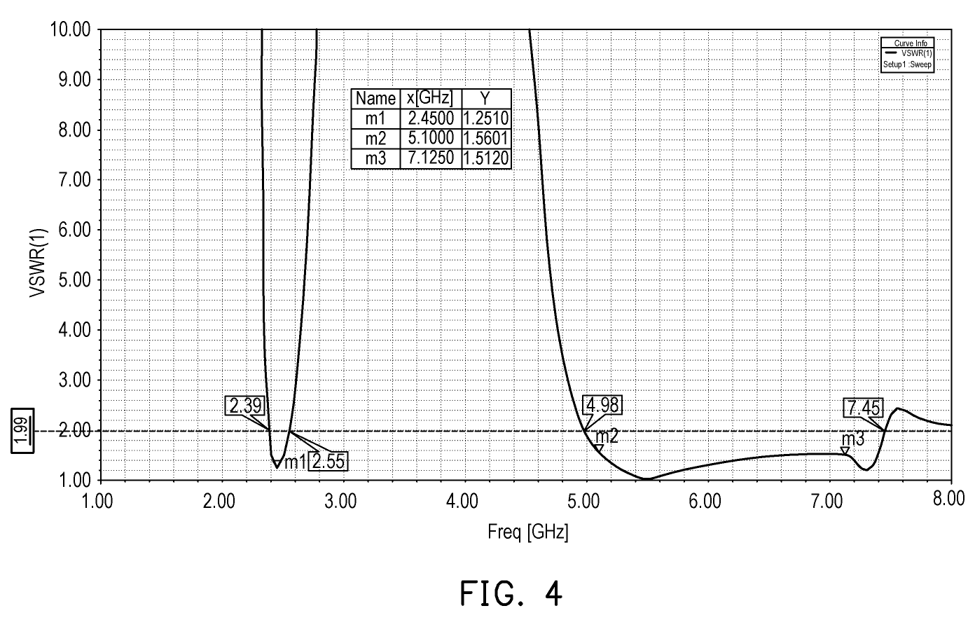

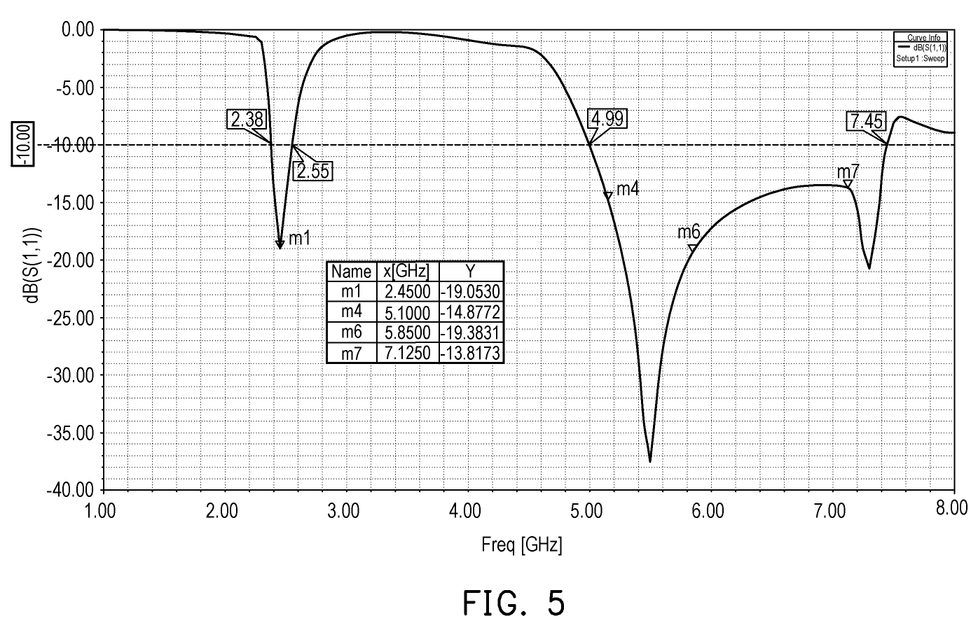

FIG. 4 is a relationship diagram of voltage standing wave ratio (VSWR) versus frequency (Freq) of the antenna module of FIG. 1. FIG. 5 is a relationship diagram of return loss versus frequency (Freq) of the antenna module of FIG. 1. Generally, smaller VSWR and return loss will obtain the optimal power output, with ideal values of VSWR = 1 and return loss = -∞, which may achieve maximum power with zero reflection.

Referring to FIGS. 4 and 5, in this embodiment, in the frequency range of 2.38 to 7.45GHz, the conditions of VSWR ≤ 2 and return loss ≤ -10db may be achieved. Therefore, the antenna module 100 of the disclosure may achieve optimal power output, which is better than traditional dipole antennas.

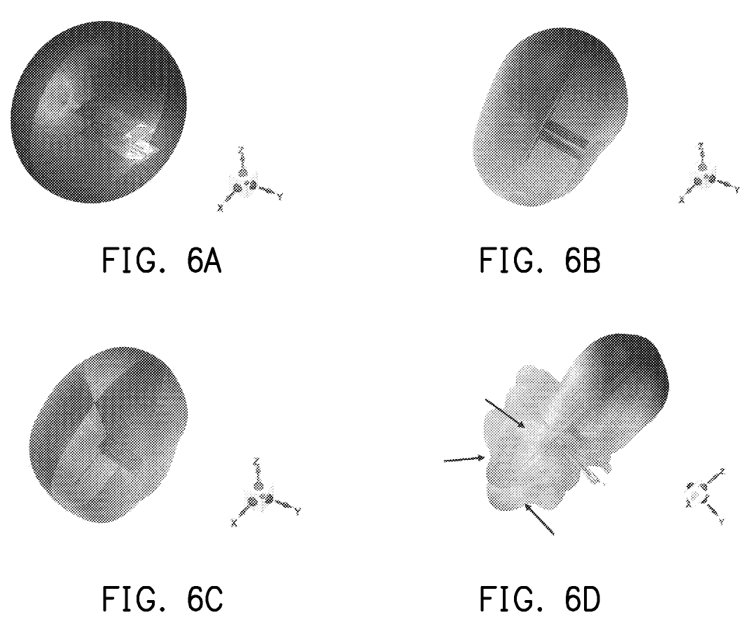

FIGS. 6A to 6D are diagrams of the radiation pattern of electromagnetic wave of the antenna module of FIG. 1 at different frequencies. It should be noted that FIG. 6A illustrates the radiation pattern of electromagnetic wave at 2.4GHz, FIG. 6B illustrates the radiation pattern of electromagnetic wave at 5.15GHz, FIG. 6C illustrates the radiation pattern of electromagnetic wave at 5.85GHz, and FIG. 6D illustrates the radiation pattern of electromagnetic wave at 7.125GHz.

Referring to FIGS. 6A to 6D, in this embodiment, the antenna module 100 is applicable for transmitting the omnidirectional radiation pattern of electromagnetic wave at various frequencies. At 2.4GHz, 5.15GHz and 5.85GHz, the omnidirectionality of the radiation pattern of electromagnetic wave is respectively maintained, and the radiation pattern of electromagnetic wave of the antenna module 100 at 7.125GHz is only slightly compressed, but is more omnidirectional than the known radiation pattern of electromagnetic wave at 7.125GHz. From this, it can be seen that the antenna module 100 of the disclosure may avoid the problem of directionality caused by the compression of the radiation pattern of electromagnetic wave in conventional designs, and may exhibit superior performance compared to traditional dipole antennas.

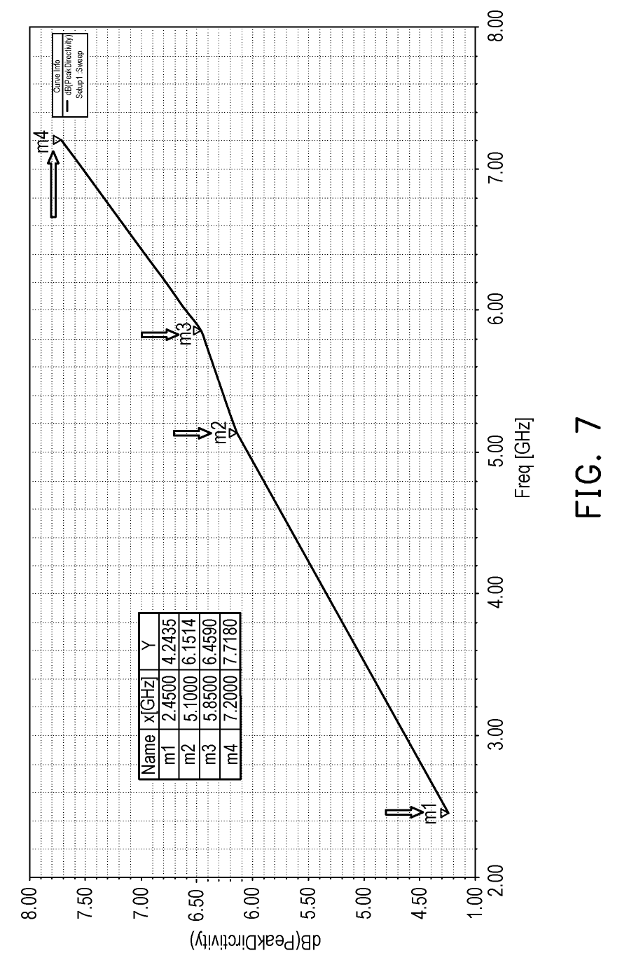

FIG. 7 is a relationship diagram of gain versus frequency (Freq) of the antenna module of FIG. 1. Referring to FIG. 7, in this embodiment, the antenna module 100 may achieve improvement in gain at various frequencies. The antenna module 100 may not only be applied to frequencies of 2.4 GHz and 5GHz, but also includes frequencies below 7.20GHz, and may be used for Wi-Fi 6E and Wi-Fi 7. The usable frequencies for Wi-Fi 6E are 2.4 GHz, 5 GHz, and 6 GHz (frequency range is 5.925 GHz to 7.125 GHz). The usable frequencies for Wi-Fi 7 are 2.4GHz, 5 GHz, and 6 GHz, which are the same as Wi-Fi 6E, but with a larger bandwidth.

FIG. 8 is a schematic diagram of an electronic device according to an embodiment of the disclosure. The antenna module 100 of the disclosure may be installed in electronic devices 70 such as remote controllers, drones, network wireless routers, etc., without limitation thereto, and is advantageous for installation in any electronic device 70 that needs to wirelessly transmit electromagnetic wave signals. The electronic device 70 includes at least a processor 90 and the antenna module 100. The processor 90 is electrically connected to the antenna module 100 for transmitting electrical signals. In an embodiment, the electronic device 70 transmits electromagnetic wave signals to the external electronic device 80. In another embodiment, the electronic device 70 receives electromagnetic wave signals transmitted from the external electronic device 80. In yet another embodiment, the electronic device 70 may transmit and receive electromagnetic wave signals. Further explaining, in an embodiment, the processor 90 of the electronic device 70 may provide electromagnetic wave signals to the feed source F1 of the antenna module 100. In another embodiment, the processor 90 of the electronic device 70 may receive electromagnetic wave signals from the feed source F1. In another embodiment, the processor 90 of the electronic device 70 may provide and receive electromagnetic wave signals from the feed source F1. The processor 90 is configured to process electromagnetic wave signals, such as converting them into digital signals, and the processor 90 may be at least one wireless communication chip, circuit, and radio frequency chip.

In summary, the embodiments of the disclosure have at least one of the following advantages or effects. In the design of the antenna module of the disclosure, the first length of the first wire pattern of the antenna structure is greater than the second length of the second wire pattern, and the projection of the antenna structure on the reflection plate at least partially overlaps the reflection pattern on the reflection plate. By adjusting the impedance of electromagnetic wave signal transmission and matching with the reflection pattern of the reflection plate, the antenna module of the disclosure has the effect of improved gain and maintains the omnidirectionality of the radiation pattern of electromagnetic wave, and may also effectively reduce the volume of the antenna module.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An antenna module, comprising:
an antenna plate, comprising:
a first base plate; and
an antenna structure, disposed on the first base plate, wherein the antenna structure comprises:
a feed source;
a plurality of first wire patterns, wherein each of the first wire patterns is arranged symmetrically with the feed source as a center, each of the first wire patterns is configured to transmit a first electromagnetic wave signal having a first frequency, and each of the first wire patterns has a first length; and
a plurality of second wire patterns, wherein each of the second wire patterns is arranged symmetrically with the feed source as a center, each of the second wire patterns is configured to transmit a second electromagnetic wave signal having a second frequency, each of the second wire patterns has a second length, and the first frequency is less than the second frequency and the first length is greater than the second length; and
a reflection plate, comprising:
a second base plate; and
a reflection pattern, disposed on the second base plate, wherein a projection of the antenna structure on the reflection plate at least partially overlaps the reflection pattern.

2. The antenna module according to claim 1, wherein the antenna plate is parallel to the reflection plate.

3. The antenna module according to claim 1, wherein there is a distance between the reflection plate and the antenna plate.

4. The antenna module according to claim 1, wherein each of the first wire patterns comprises a first section, a second section, a third section, and a fourth section, the first section is connected to the feed source, and the first section, the second section, the third section, and the fourth section are sequentially connected to form a plurality of bends.

5. The antenna module according to claim 4, wherein the first section and the third section extend along a first direction, the fourth section extends along a second direction, the second section is tilted with respect to the first direction and the second direction, and the first direction is perpendicular to the second direction.

6. The antenna module according to claim 5, wherein the first direction is parallel to a first side of the first base plate, and the second direction is parallel to a second side of the first base plate.

7. The antenna module according to claim 5, wherein each of the second wire patterns comprises a fifth section, a sixth section, and a seventh section, the fifth section is connected to the feed source, and the fifth section, the sixth section, and the seventh section are sequentially connected to form a plurality of bends.

8. The antenna module according to claim 7, wherein the fifth section and the seventh section extend along the second direction, and the sixth section extends along the first direction.

9. The antenna module according to claim 1, wherein the reflection pattern further comprises a first section and two second sections, and the two second sections are parallel to the first section and respectively located on two opposite sides of the first section.

10. The antenna module according to claim 9, wherein a length of each of the second sections is less than a quarter wavelength of the first frequency.

11. The antenna module according to claim 9, wherein a length of each of the second sections is between 20 and 25 millimeters.

12. The antenna module according to claim 9, wherein the second base plate comprises two opposite first sides and two opposite second sides, the two first sides are perpendicular to the two second sides, the first section is parallel to each of the first sides, and two ends of the first section are respectively located at midpoint positions of the two second sides of the second base plate.

13. The antenna module according to claim 12, wherein the reflection pattern further comprises at least one extension part and at least one corner part, the reflection plate is rectangle, the at least one corner part is located in at least one of the four corners of the reflection plate, and the extension part is parallel to each of the second sides and located between the first section and the at least one corner part.

14. The antenna module according to claim 13, wherein there is a gap between two opposite ends of each of the second sections and the at least one extension part.

15. The antenna module according to claim 13, wherein a number of the at least one extension part is two, which are located on the two second sides.

16. The antenna module according to claim 13, wherein a number of the at least one corner part is four, which are located at the four corners of the reflection plate.

17. The antenna module according to claim 13, wherein a shape of the at least one corner part is triangle.

18. An electronic device, comprising at least:
a processor; and
an antenna module, electrically connected to the processor, and comprising:
an antenna plate, comprising:
a first base plate; and
an antenna structure, disposed on the first base plate, wherein the antenna structure comprises:
a feed source;
a plurality of first wire patterns, wherein each of the first wire patterns is arranged symmetrically with the feed source as a center, each of the first wire patterns is configured to transmit a first electromagnetic wave signal having a first frequency, and each of the first wire patterns has a first length; and
a plurality of second wire patterns, wherein each of the second wire patterns is arranged symmetrically with the feed source as a center, each of the second wire patterns is configured to transmit a second electromagnetic wave signal having a second frequency, each of the second wire patterns has a second length, and the first frequency is less than the second frequency and the first length is greater than the second length; and
a reflection plate, comprising:
a second base plate; and
a reflection pattern, disposed on the second base plate, wherein a projection of the antenna structure on the reflection plate at least partially overlaps the reflection pattern.
